(19) United States
(12) Patent Application Publication
(10) Pub. No.: US 2021/0239976 A1
(43) Pub. Date: Aug. 5, 2021

(54) INDUSTRIAL HEAD UP DISPLAY

(71) Applicant: Unity Technologies ApS, Copenhagen (DK)

(72) Inventors: Steven William Pridie, Burnaby (CA); David Gordon, Port Coquitlam (CA)

(21) Appl. No.: 17/169,335

(22) Filed: Feb. 5, 2021

Related U.S. Application Data
(60) Provisional application No. 62/970,521, filed on Feb. 5, 2020.

(51) Int. Cl. G02B 27/01; G02B 27/00

(52) U.S. Cl. CPC G02B 27/0101; G02B 27/0093; G02B 2027/0127; G02B 2027/0118; G02B 2027/013

(57) ABSTRACT

A method of generating a target display within an environment is disclosed. Data is gathered and analyzed data from one or more environmental sensors to determine a target distance from a point within the system to a target display area within the environment. A distance between a projector and a concave mirror is modified to adjust a distance of a focal plane from the point within the system in order to match the determined target distance. The focal plane is associated with the target display.

### CROSS-REFERENCE TO RELATED APPLICATIONS

This application claims the benefit of U.S. Provisional Application No. 62/970,521, filed Feb. 5, 2020, entitled “INDUSTRIAL HEAD UP DISPLAY,” which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### MASK WORK NOTICE

A portion of the disclosure of this patent document contains material which is subject to mask work protection. The mask right owner has no objection to the facsimile reproduction by anyone of the patent document or the patent disclosure, as it appears in the Patent and Trademark Office patent file or records, but otherwise reserves all mask work rights.

### TECHNICAL FIELD

The subject matter disclosed herein generally relates to the technical field of Head-Up Displays (HUDs), and in one specific example, to HUDs for use in industrial applications with heavy and industrial machinery.

### BACKGROUND OF THE INVENTION

This disclosure relates to Head-Up Displays (HUDs), especially HUDs for use in industrial applications with heavy and industrial machinery. One problem with industrial machinery (referred to herein as ‘machinery’, ‘industrial equipment’, or simply ‘equipment’) is that a worker may be forced to work in unusual and irregular environments typically associated with construction and mining. For example, the environments may be on hillsides, fields, unpaved roads (or other unpaved locations), and be in rural locations away from buildings and other environmental obstacles that might otherwise beneficially block wind and/or sunlight. Accordingly, an irregular environment may have poor visibility, or the equipment may operate in environments that are unstable or that include obstacles or hazards to be avoided. For example, when operating industrial machinery for an excavation, the machinery may need to be used at night under poor lighting conditions, during the day with sunlight directly in the face of an operator, in poorly lit areas such as caves, catacombs, sewers, mines, and on or near unstable, decaying construction. Additionally, due to a typically large size of industrial equipment (e.g., including vehicles) and environmental factors, it may be difficult for an operator to both direct a vehicle (or piece of equipment), and to accomplish a specific task associated with a job such as excavating soil, demolishing environmental objects, or moving construction materials from place to place.

In another example, one or more dump trucks may be tasked with moving mined material from a first location to a second location in an irregular environment that includes unpaved or irregular roads; for example the one or more dump trucks may need to move mined material from an excavation site to a processing facility or to a refuse pile, or from a processing facility to a refuse pile or other location. Accordingly, the roads may be in poor quality (e.g., a road may merely be tracks from a previous passing of a truck), and may be single-file with obstructed views, and may include large amounts of dust or particulate matter. In other instances, the roads or path to be taken by a vehicle may not be defined or may only be defined within certain parameters (e.g. within a fixed area). Within these irregular environments and conditions, it may be up to an operator of machinery to select a path, or simply forge one using a combination of judgment, experience, and assistance from data provided on a HUD. Typical HUDs are not appropriate in solving these issues since typical HUDs do not augment specific elements within an environment (e.g., the road) nor assist an operator in selecting a path for a vehicle. In addition, typical windshield HUDs may be dangerous since rough and irregular environments require an operator's eyes to be on a path at all times to avoid hazards, and repeatedly glancing to a HUD on a windshield is distracting and may be dangerous in such situations.

An organization system including a HUD overlay may potentially assist an operator using industrial equipment (e.g., by augmenting a view of the operator), however existing HUDs are not well designed for such tasks within irregular environments. In particular, existing HUDs are designed to operate only in specific conditions, and with limited functionality. Additionally, most HUDs simply overlay content over a field of vision and do not dynamically adapt (e.g., to environmental conditions) or perform calculations to further augment a view of a user. For example, in industrial applications and equipment, operator cabins are large and designed to enable an operator to move in such a way as to see more of the environment (e.g. head and body of an operator may move within a large area within the cabin). Accordingly, objects beyond the focal plane for which a traditional HUD is designed to operate will lose alignment when the head of an operator moves any significant amount (e.g., front to back or side to side).

### BRIEF DESCRIPTION OF THE DRAWINGS

Features and advantages of example embodiments of the present disclosure will become apparent from the following detailed description, taken in combination with the appended drawings, in which:

FIG. 1A is a schematic illustrating a dynamic focal plane head up display (HUD) system, in accordance with one embodiment;

FIG. 1B is a schematic illustrating a dynamic focal plane head up display (HUD) system, in accordance with one embodiment;

FIG. 2 is a schematic illustrating a dynamic focal plane head up display (HUD) system integrated into a cabin of an industrial machine, in accordance with one embodiment;

FIG. 3 is a flowchart of a method for generating a HUD with a long throw distance with adjustable focal plane depth and angle, in accordance with an embodiment;

FIG. 4 is a schematic illustrating a dynamic focal plane HUD system within a dump truck near an incline, in accordance with an embodiment;

FIG. 5 is a schematic illustrating a dynamic focal plane HUD system within a shovel truck near an incline, in accordance with an embodiment;

FIG. 6 is a block diagram illustrating an example software architecture, which may be used in conjunction with various hardware architectures described herein; and

FIG. 7 is a block diagram illustrating components of a machine, according to some example embodiments, configured to read instructions from a machine-readable medium (e.g., a machine-readable storage medium) and perform any one or more of the methodologies discussed herein.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that various embodiments of the inventive subject matter may be practiced without these specific details.

A method of generating a target display within an environment is disclosed. Data is gathered and analyzed data from one or more environmental sensors to determine a target distance from a point within the system to a target display area within the environment. A distance between a projector and a concave mirror is modified to adjust a distance of a focal plane from the point within the system in order to match the determined target distance. The focal plane is associated with the target display.

The present disclosure describes apparatuses which perform one or more operations or one or more combinations of operations described herein, including data processing systems which perform these operations and computer readable media storing instructions that, when executed by one or more computer processors cause the one or more computer processors to perform these operations, the operations or combinations of operations including non-routine and unconventional operations or combinations of operations.

The systems and methods described herein include one or more components or operations that are non-routine or unconventional individually or when combined with one or more additional components or operations, because, for example, they provide a number of valuable benefits to an operator of industrial machinery (referred to herein as ‘machinery’, ‘industrial equipment’, or simply ‘equipment’). For example, the systems and methods described herein may adjust a focal plane depth and angle (e.g., tilt) for a head up display (HUD) system in order to adjust for operator movement or an uneven target display area. In addition, the systems and methods described herein may adjust a brightness and contrast in a HUD system in order to adjust for environmental conditions surrounding the HUD system.

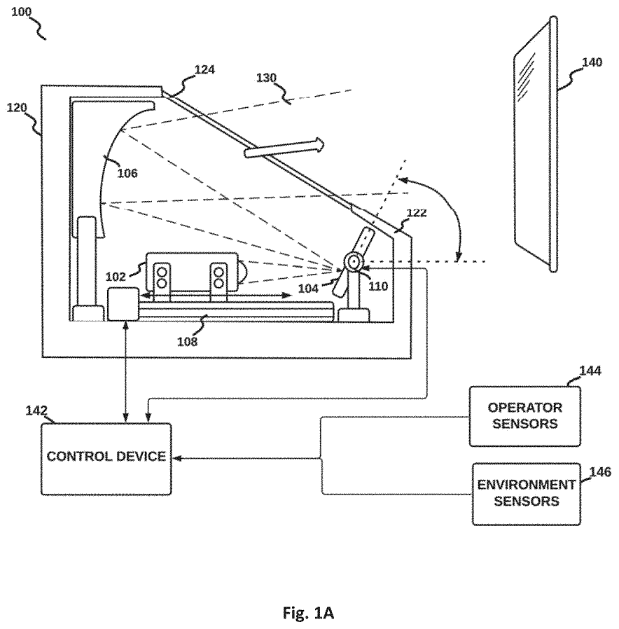

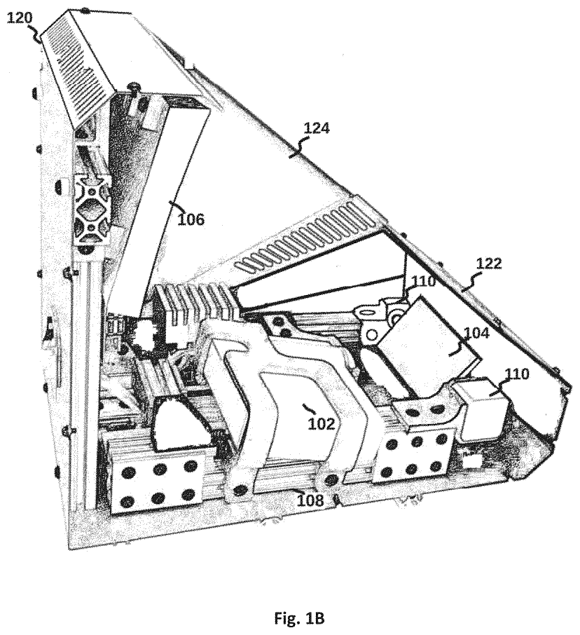

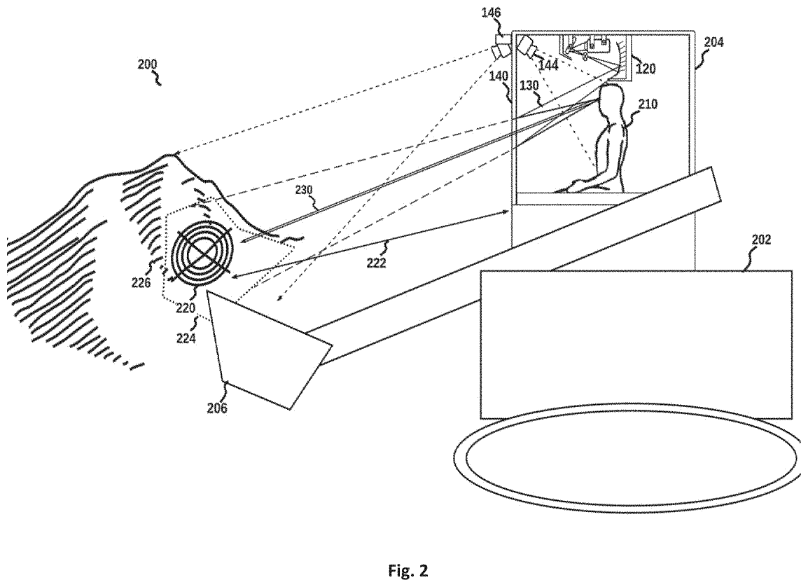

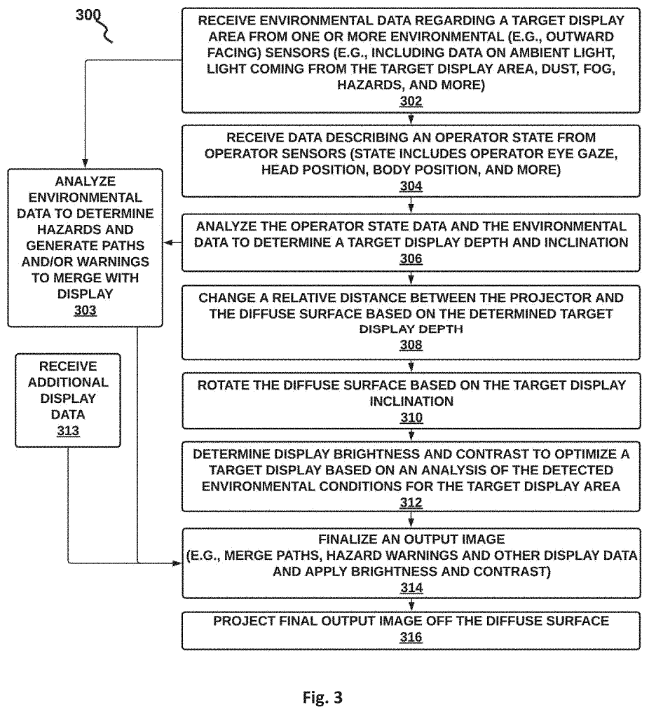

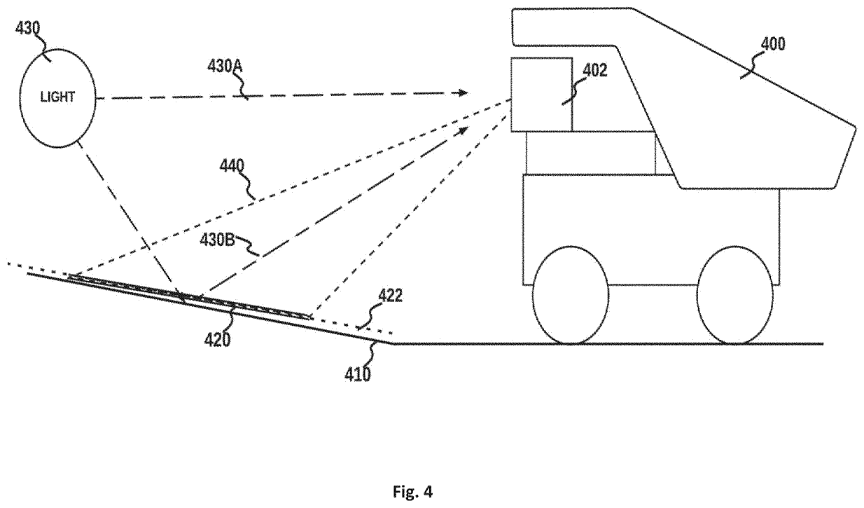

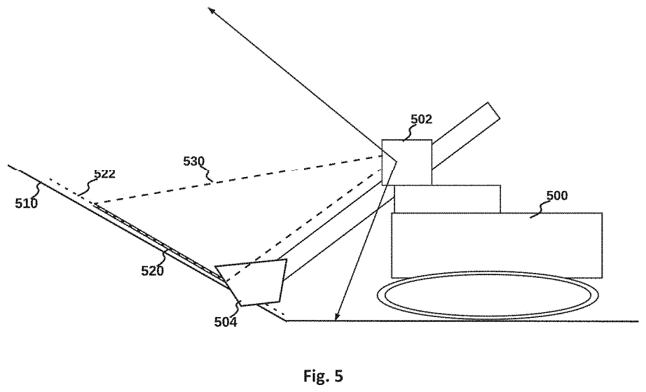

One aspect of the systems and methods described herein (e.g., with respect to FIG. 1A, FIG. 1B, FIG. 2, FIG. 3, FIG. 4, and FIG. 5) is to display information which is spatially aligned with a focal plane of a point of focus of an operator of industrial equipment. As an example, based on the industrial equipment being an excavator, the systems and methods described herein (e.g., with respect to FIG. 1A, FIG. 1B, FIG. 2, FIG. 3, FIG. 4, and FIG. 5) may include augmenting a display to incorporate information related to a bucket and/or dig-face of the excavator. As another example, based on the industrial equipment being a haul truck, a HUD system (e.g., as described with respect to FIG. 1A, FIG. 1B, FIG. 2, FIG. 3, FIG. 4, and FIG. 5) may incorporate information related to terrain surrounding the haul truck, other vehicles moving in proximity to the haul truck, and/or a road in proximity to the haul truck. In the above mentioned examples, it may be helpful for an operator to have additional information and/or to see portions of the equipment or environment clearly; however, industrial equipment operates in difficult environments wherein a view of the equipment and/or environment may be distorted, obstructed (e.g., covered by the environment or the equipment itself), obscured by dust or debris, out of view, dim, heavily backlit, or otherwise difficult to make out with unassisted vision. Existing HUDs are limited in functionality to respond to such challenges; for example, displaying only numerical information (e.g. speeds or status) and in a fixed position on a projection surface (e.g. a windshield of a truck). In accordance with an embodiment, the systems and methods described herein (e.g., with respect to FIG. 1A, FIG. 1B, FIG. 2, FIG. 3, FIG. 4, and FIG. 5) may use one or more sensors such as an outward-facing camera, outward-facing infrared camera, LIDAR, or similar scanner in order to detect specific information about an environment surrounding an industrial machine (e.g. detecting physical objects, slopes, potholes, hazards, fallen trees, debris, buildings, other equipment, etc.) and use the detected information to adapt a display for an operator in order to optimize a viewing of the operator.

Furthermore, existing HUDs have fixed focal plane distances (e.g., typically 1-2 m beyond a projection surface) which may introduce a large parallax error. For example, in industrial equipment, operator cabins are often large and designed to enable an operator to move in such a way as to see more of an environment, whereby objects beyond a fixed focal plane for which a traditional HUD is designed to operate will lose alignment based on significant head movement from an operator.

The systems and methods described herein (e.g., with respect to FIG. 1A, FIG. 1B, FIG. 2, FIG. 3, FIG. 4, and FIG. 5) may address some of the issues described above by describing a dynamic focal plane head up display system that can target a variable focal plane. The systems and methods may detect a slope or alignment of exterior objects (e.g., a road, a hillside, a physical object, and the like) and may dynamically adjust a distance and alignment between a reflecting mirror and a projector to cause an image from the projector to project in such a way that a display (e.g., as seen by an operator) aligns with the slope and/or object. The dynamic adjustment of the distance and alignment modifies a focal plane (e.g., distance to the focal plane, tilt of the focal plane, location of the focal plane) of a virtual image (generated by the projector).

In addition, when operating in industrial environments using large equipment, an operator may be focusing a distance of 20-60 feet from the cabin of the equipment (or further in the case of cranes). The systems and methods described herein (e.g., with respect to FIG. 1A, FIG. 1B, FIG. 2, FIG. 3, FIG. 4, and FIG. 5) may make a large adjustment to a focal length for a HUD in order to enable a display overlay to “appear” as though it is at the same depth at which the operator is looking. Otherwise, operators may continually change focus from a distant work environment to a close display (e.g., on a windshield) causing eye strain. The systems and methods described herein (e.g., with respect to FIG. 1A, FIG. 1B, FIG. 2, FIG. 3, FIG. 4, and FIG. 5) may reduce eye strain over time by adjusting a focal plane of a HUD system such that a display image can appear to be at a same location of a focus of an operator. The systems and methods described herein (e.g., with respect to FIG. 1A, FIG. 1B, FIG. 2, FIG. 3, FIG. 4, and FIG. 5) may include cameras and other sensors pointed at an operator of a piece of industrial equipment, and that track eye and head movements of the operator. Additionally, outside of the industrial equipment (or inside but facing away from the operator) other cameras and sensors may detect elements of an environment surrounding the piece of industrial equipment and use all the gathered data in combination to generate images for a HUD that appear position-correct relative to objects exterior to the equipment, and relative to the operator within the equipment.

Turning now to the drawings, systems and methods, including non-routine or unconventional components or operations, or combinations of such components or operations, for dynamic focal plane manipulation in a head up display (HUD) in accordance with embodiments that are illustrated. In accordance with an embodiment, FIG. 1A is a diagram of an example dynamic focal plane head up display system 100 (or ‘dynamic focal plane HUD’). In accordance with an embodiment, the dynamic focal plane HUD system 100 includes a projector 102, a diffuse surface 104, a concave mirror 106, a motorized rotation stage 110, a motorized stage 108, a control device 142, a combiner 140, and environment sensors 146. In accordance with some embodiments, the dynamic focal plane HUD system 100 may also include operator sensors 144. In accordance with an embodiment, the motorized stage 108 may be configured for moving the projector 102 in a linear translation to adjust a distance between the projector 102 and the diffuse surface 104. In accordance with an embodiment, the motorized stage 108 may be configured to move linearly in one dimension, two dimensions (e.g., an X-Y stage), or three dimensions (e.g., an X-Y-Z stage). In accordance with an embodiment, the diffuse surface 104 may be mounted on the motorized rotation stage 110 such that the surface may be rotated (e.g., tilted) with respect to the projector 102 and mirror 106. In accordance with an embodiment the projector 102, diffuse surface 104, concave mirror 106, motorized rotation stage 110, and a motorized stage 108 may all be within a housing structure 120. In accordance with an embodiment, the mirror 106, the motorized stage 108, and the motorized rotation stage 110 may be fixed to an inside of the housing structure 120. In accordance with an embodiment, the housing structure may include an overhang 122 to shield the diffuse surface 104 from stray ambient light (e.g., light from external to the dynamic focal plane HUD system 100). In accordance with an embodiment, the housing structure 120 may include an exit window 124 out of which light 130 from the projector may exit. In accordance with an embodiment, the exit window 124 may include a transparent material (e.g., glass or plastic), while in other embodiments the exit window 124 may not have any material (e.g., leaving an opening in the housing structure) out of which light 130 from the projector may exit.

In accordance with an embodiment, the combiner may be a transparent material such as glass, plastic, polymer or other which partially reflects light from the projector to an operator and also allows light from a surrounding environment through to the operator. The combiner allows the image from the projector to be superimposed on a view of the surroundings. In accordance with an embodiment, the combiner may be a flat window shaped structure, and in other embodiments the combiner may be curved such that it has an optical power (e.g., a curved window shaped structure). In accordance with an embodiment, the combiner may be made of a transparent material including glass, plastic, polymer, or the like.

In accordance with an embodiment, the projector 102 may be any projector powerful enough to have a sufficiently bright display. In accordance with an embodiment, the projector 102 may include LCDs (liquid crystal displays) since LCDs achieve contrast ratios required given a wide range of lighting environments (e.g. extremely bright and extremely dark conditions). For example, nighttime brightness is usually around 1 Lux, and daytime up to 10,000 Lux. In order to make a display bright enough, the projector 102 may be a high power projector that includes LCD augmentation to improve a contrast ratio to work suitably at night or in bright daylight.

In accordance with an embodiment, the diffuse surface 104 may be a surface that diffuses light isotropically or anisotropically. The diffuse surface 104 may be manufactured to diffuse light preferentially in a cone (e.g., a 45 degree cone) around an angle of incidence for incident light in order to maintain good optical efficiency as the surface is rotated (tilted) during operation. For example, in accordance with an embodiment, the diffuse surface may be a partially roughened metal surface (e.g., brushed metal).

In accordance with an embodiment, the concave mirror may be an off-axis mirror. In accordance with an embodiment, the mirror 106 may be any concave shape, including: parabolic, spherical, and dynamically alterable “freeform” mirrors that can be altered in real-time to a desired shape. In accordance with an embodiment, the mirror 106 may have a focal length which minimizes a size of the housing structure 120, while allowing reflected light to pass through the exit window 124. In accordance with an embodiment, the mirror 106, the diffuse surface 104, and the projector 102 may be positioned such that an image formed by the projector 102 is within a focal length distance from the mirror. Accordingly, light for a virtual magnified version of the image is reflected off the mirror 106 towards the combiner 140 and reflected again towards an operator (e.g., as shown in FIG. 2). The virtual magnified image as seen by the operator is the target image (e.g., is the heads up display). A movement of the image formed by the projector 102 towards or away from the mirror 106 moves the virtual magnified version of the image away or towards the combiner (e.g., and the operator), respectively. In accordance with an embodiment, the movement of the image formed by the projector 102 may be accomplished by moving the projector along the motorized stage 108. In accordance with an embodiment, though not shown in FIG. 1A, the projector 102 may be stationary and the mirror 106 may be on movable mount which moves the mirror 106 towards or away from the diffuse surface 104 and projector 102.

In accordance with an embodiment, the control device 142 may be a computing device that includes one or more central processing units (CPUs) and Graphics processing units (GPUs). The processing device is any type of processor, processor assembly comprising multiple processing elements (not shown), having access to a memory to retrieve instructions stored thereon, and execute such instructions. Upon execution of such instructions, the instructions implement the processing device to perform a series of tasks as described herein in reference to FIG. 2, FIG. 3, FIG. 4, and FIG. 5. The control device 142 also includes one or more networking devices (e.g., wired or wireless network adapters) for communicating across a network. The control device 142 also includes a memory configured to store a dynamic focal plane HUD module. The memory can be any type of memory device, such as random access memory, read only or rewritable memory, internal processor caches, and the like. In accordance with an embodiment, though shown separately from the housing structure 120, the control device 142 may be integrated into the housing structure 120.

In accordance with an embodiment, though not shown in FIG. 1A, the operator sensors 144, environment sensors 146, control device 142 may be coupled in networked communication via a network (e.g., a cellular network, a Bluetooth network, Wi-Fi network, the Internet, Local-Area-Network (LAN), and so forth).

In accordance with an embodiment, FIG. 1B shows a schematic drawing of the dynamic focal plane HUD system 100 shown in FIG. 1A. In accordance with an embodiment, as shown in FIG. 2, the dynamic focal plane HUD system 100 may have a compact configuration with a folded optical path from the projector 102 to the mirror 106 via a reflection off the diffuse surface 104.

In accordance with an embodiment, FIG. 2 shows an implementation of the dynamic focal plane HUD system 100 within a cabin 204 of an industrial machine 202 (e.g., an excavator) operating within an environment 200 (e.g., a construction site, a mining site, or any irregular site). While shown within an excavator 202 in FIG. 2, embodiments of this present disclosure are not limited in this regard. Any industrial machine (e.g., including dump trucks, industrial shovels, dig trucks, buckets, cranes, tractors, pallet drivers, pipeline transport vehicles, mining equipment, farming equipment, ocean equipment, and more) can be used to illustrate the dynamic focal plane HUD system 100. In the example embodiment shown in FIG. 2, the housing structure 120 may be attached to a ceiling above an operator 210 within the excavator cabin 204 such that light 130 exiting the housing structure (e.g., via the exit window 124) may hit a combiner 140 on a front of the cabin 204 and may overlap with a view of the environment 200. In accordance with an embodiment, a target display 220 for the dynamic focal plane HUD system 100 is seen by the operator 210 from light 130 reflected off the combiner 140 such that the target display 220 appears to originate at a distance 222 from the cabin and on a target display area 224 in the environment. The distance 222 from the cabin may be controlled by the relative distance between the projector 102 and the mirror 106 such that moving of the projector 102 relative to a fixed mirror 106 or moving the mirror 106 relative to a fixed projector will modify the distance 222. In accordance with an embodiment, for practical reasons (e.g., mirror vibration, optical alignment, and others), it may be more desirable to move the projector 102 as shown in FIG. 1A.

In accordance with an embodiment, and as shown in FIG. 2, the environment sensors 146 may be mounted on an exterior portion of the cabin 204, and pointed in a direction that overlaps a view 230 of the operator 210 (e.g., a view of the target display area 224). While shown in FIG. 2 as a single environment sensor 146, it should be understood that a plurality of environment sensors 146 (e.g., one or more RBG cameras, one or more infrared cameras, and the like) may be mounted on the cabin 204 (or other parts of the industrial machine 202), in order to gather data describing the environment 200 in one or more directions.

In accordance with an embodiment, and as shown in FIG. 2, the operator sensors 144 may be mounted on an interior portion of the cabin 204, and pointed in a direction that overlaps the operator 210. While shown in FIG. 2 as a single operator sensor 144, it should be understood that a plurality of operator sensors 144 (e.g., one or more RBG cameras, one or more infrared cameras, and the like) may be mounted in the cabin 204 (or other parts of the industrial machine 202), in order to gather data describing the operator 210 in one or more directions.

In accordance with an embodiment, and as shown in FIG. 2 and described below with respect to a method shown in FIG. 3, the target display 220 may appear to be tilted by the operator to match a slope of the environment 200 (e.g., within the target display area 224) as detected by the eternal sensors 146. In accordance with an embodiment, and described below with respect to a method shown in FIG. 3, the slope of the environment 200 may be determined by analyzing the operator sensors 144 to determine a gaze 230 of the operator 210 in order to determine a specific area of the environment over which to analyze a slope (e.g., wherein the specific area is referred to as the target display area 224). In accordance with an embodiment, the target display area 224 may be determined dynamically based on the gaze of the operator 210. The orientation of the target display 220 is controlled by a rotation (e.g., tilting) of the diffuse surface 104 by the motorized rotation stage 110.

In accordance with an embodiment, though not shown in FIG. 2, the target display 220 may be projected onto a part of the industrial machine 202. For example, the target display 220 may be projected onto a bucket 206 by tracking a position and orientation of the bucket 206 with the external sensors 146 and moving the projector 102 (e.g., along the motorized stage 108) and diffuse surface 104 accordingly (e.g., tilting or rotating the diffuse surface 104 using the motorized rotation stage 110).

In accordance with an embodiment, FIG. 3 is a flowchart of a method 300 for generating a HUD with a long throw distance to a focal plane and adjusting a depth and angle for the focal plane in order to compensate for operator movement or an uneven target display area. The method 300 may be used in conjunction with the dynamic focal plane HUD system 100 as described with respect to FIG. 1A, FIG. 1B, and FIG. 2. In various embodiments, some of the method elements shown may be performed concurrently, in a different order than shown, or may be omitted. In accordance with an embodiment, at operation 302 of the method 300, the dynamic focal plane HUD module receives environmental data regarding a target display area 224 from one or more environmental sensors 146 (e.g., as shown in FIG. 2). The environmental data may include video, infrared or other sensor data describing the environment 200, and in some embodiments the environmental data may include data specifically describing a target display area 224 and an optical path from an operator to the area 224. In accordance with an embodiment, the environmental data may be used to dynamically determine the target display area 224 and properties of the target display area 224 (e.g., a brightness of the target display area, a slope of the target display area, and the like).

In accordance with an embodiment, at operation 304 of the method 300, the dynamic focal plane HUD module receives data describing an operator state from operator sensors 144 (e.g., as shown and described with respect to FIG. 2). In accordance with an embodiment, the received operator data includes data describing a state of the operator, including one or more of body position, head position, eye gaze (or line of sight), and more. In accordance with an embodiment, the data may include RGB video, infrared data, and other data which may be analyzed (e.g., using artificial intelligence, image analysis techniques, and the like) in order to determine a state of the operator over time. To accommodate a large range of motion that counter-acts potential operator head (and eye) movement within a cabin 204 of an industrial machine 202, the operator sensors 144 may be used to detect a location of head and eyes of the operator 210 to thereby perform head tracking. By installing one or more operator sensors within the cabin 204, near the head of the operator 210, the head and eye positions may be tracked (e.g., including gaze tracking). Using data obtained from the tracking, and after analyzing data received regarding the environment 200 (e.g., including the target display area 224 as received during operation 302), the target display 220 may be adjusted (as further described in operation 306) to account for parallax from perspective of the operator (e.g., operator eye position). In accordance with an embodiment, the adjustment may be within a threshold closeness to an optimal adjustment in order to make the target display 220 readable within the difficult operating environment. in which an operator works.

In accordance with an embodiment, at operation 306 or the method 300, the dynamic focal plane HUD module analyzes the operator state data (e.g., received from the operator sensors 144 as described with respect to operation 304) and the environmental data (e.g., received from the environmental sensors 146 as described with respect to operation 302) to determine a target depth and a target orientation (e.g., inclination) for a target display 220, wherein the target depth and target orientation (e.g., inclination) match (e.g., within a predetermined threshold) a real-world depth and a real-world slope of a target display area 224 in the environment 200, and on which the target display 220 is to appear to the operator (e.g., when looking through the combiner 140). In accordance with an embodiment, operation 306 may include applying image analysis techniques to video from the environment sensors 146) of the environment 200 in order to determine the real-world slope and the real-world depth of the target display area 224. The analysis may be done dynamically to determine the real-world slope and real-world depth over time (e.g., as an industrial machine moves over time). In accordance with another embodiment, operation 306 may include analyzing infrared data (e.g., depth data) of the environment 200 (from the environment sensors 146) in order to determine the real-world slope and the real-world depth of the target display area 224. In accordance with another embodiment, operation 306 may include using artificial intelligence (AI) techniques to analyze the environment data from the environment sensors 146 in order to determine the real-world slope and the real-world depth of the target display area 224. The AI techniques may include training an AI agent to recognize a real-world slope and a real-world depth from environment sensor 146 data. There are numerous ways of determining the target orientation (e.g., inclination) in order to tilt the target display 220 as seen by an operator (e.g., through the combiner 140). For example, the environment sensors 146 (e.g. camera, infrared, light field, LIDAR, etc.) may gather data about an angle of a real-world slope near the target display area 224, and use the angle to calculate how much to tilt the diffuse surface 104 (e.g., or tilt the mirror 106). For example, based on an operator working on a 12-degree slope, the target display 220 may be titled by 12° or another value of degree that will cause the virtual image to be tilted by 12°.

In accordance with an embodiment, at operation 308 of the method 300, the dynamic focal plane HUD module communicates (e.g., provides instructions) with the motorized stage 108 to change a relative distance between the projector 102 and the diffuse surface 104 based on the determined target display depth. For example, to increase a depth of the target display (e.g., as seen by an operator looking through the combiner 140), the dynamic focal plane HUD module may instruct the motorized stage 108 to increase the relative distance (e.g., and vice versa). In accordance with an embodiment, the relative distance is maintained within a threshold that keeps an image formed by the projector 102 within a volume of space inside a focal length of the mirror 106. In accordance with an embodiment, though not shown in FIG. 1A or FIG. 1B, the motorized stage 108 may be attached to the mirror and may change the relative distance between the mirror 106 and the diffuse surface 104.

In accordance with an embodiment, at operation 310 of the method 300, the dynamic focal plane HUD module communicates (e.g., provides instructions) with the motorized rotation stage 110 to change a relative angle (e.g., tilt) of the diffuse surface 104 with respect to the projector 102 and the mirror 106 based on the determined target display orientation. In accordance with an embodiment, the relative angle may be along one or more rotation axes. In accordance with an embodiment, a rotation of the diffuse surface results in a rotation of the target display 220 as seen by an operator (e.g., through the combiner 140). In certain instances, it may be desirable to have an angled focal plane which aligns with a local topography in the target display area 224 (e.g., based on an operator working on a graded slope). Using the disclosed dynamic focal plane HUD system 100, a virtual image representing the target display image 220 may be tilted to align with the real-world target display area 224.

In accordance with an embodiment, a rotation of the diffuse surface may reduce a vertical field of view of the target display 220 for an operator 210. In accordance with an embodiment, based on a reduction of the vertical field of view (e.g., due to the titling), the dynamic focal plane HUD module may render additional digital objects that account for the loss of vertical field of view. For example, dotted or hatched lines may be generated over a displayed object in the target display 220 which has a reduced field of view in order to partially or completely restore the object to what an operator would have seen had the vertical field not been altered. In accordance with an embodiment, a small version of the object that has an affected vertical field of view may be presented in a corner of the target display 220, so the operator may be made aware of the original structure of the object (e.g., had the vertical field of view not been affected). Other variations include making the affected object a different color in the target display 220, sparkle or shine, or highlighting the object in the target display 220 by other means.

In accordance with an embodiment, at operation 312 of the method 300, the dynamic focal plane HUD module determines a brightness and contrast to optimize the target display 220 based on an analysis of detected environmental conditions (e.g., based on the received data from the environmental sensors 146) for the target display area 224. In accordance with an embodiment, the determined contrast may include colour information (e.g., using a dark colour to adjust contrast). In accordance with an embodiment, the determined brightness and contrast may apply to the entire target display 220 or to specific portions of the target display 220 (e.g., to overcome a specular reflection in the target display area 224). Accordingly, the dynamic focal plane HUD module may generate and apply a brightness profile which includes a brightness level for each part of the target display (e.g., a 2D profile of brightness over the display). Similarly, the dynamic focal plane HUD module may generate and apply a contrast profile which includes a contrast level for each part of the target display (e.g., a 2D profile of contrast over the display). For example, viewpoint specific dimming may be employed based on operator position, line of sight 230, and the environment 200. The dynamic focal plane HUD module may dynamically alter brightness and contrast of the target display 220 to account for ambient light levels within the environment 200. For example, based on an operator 210 using the dynamic focal plane HUD system 100 at night, the dynamic focal plane HUD module may make images dimmer to account for dark nighttime conditions. Similarly, based on an operator 210 using the dynamic focal plane HUD system during the day, and base on sunlight shining directly in a view 230 of the operator, the dynamic focal plane HUD module may account by dynamically adjusting a brightness of the target display 220, or by dynamically changing a contrast in the target display 220 to transition to primarily dark colors to show up better against the bright light. Doing so enables, for example, an operator 210 to see a pothole or other hazard that may be invisible while in a dark environment or while driving into blinding light of a setting sun.

In accordance with an embodiment, the determination of the display brightness and contrast may be made using the data from the environmental sensors 146 (e.g., which may include a light sensor) which detect an amount of light in the environment within the target display area 224. In accordance with an embodiment, the determining of the brightness and contrast may include data from the operator sensors 144 to determine a position and line of sight 230 of the operator 210. For example, consider an operator working on a sunny day while focusing on a shadowy coal dig face (which is dark). In the example, the environmental sensors 146 may be instructed by the dynamic focal plane HUD module to focus on a narrow field of view by tracking a line of sight 230 of the operator (e.g., by tracking eyes of the operator 210 with the operator sensors 144) and to determine that, though the day is bright, a focus of the operator is on a dark area within the targeted display area 224. As a result, instead of making a change of brightness based only on the general ambient light of the environment 200, the dynamic focal plane HUD module can adjust brightness and contrast in a targeted way based on a view 230 of the operator.

In accordance with an embodiment, the determination of the display brightness and contrast may be made using predetermined instructions for an environment 200 or parts therein. For example, an environment 200 (e.g., a particular jobsite) may include a plurality of predetermined regions that require different dimming (e.g., brightness and contrast instructions) which may be included in instructions provided to the control device 142. The instructions may include lighting schemes for the environment 200. For example, based on an industrial machine (e.g., a digger) being parked in a particular spot within the environment 200, position sensors within the environmental sensors 146 may detect a location of the industrial machine and the dynamic focal plane HUD module may use that location data to determine if the location is within a predetermined region, and then execute instructions associated with the predetermined region (e.g., to provide extra lighting for the target display 220 or to apply specific lighting schemes to appropriately illuminate a workspace for the operator 210).

In accordance with an embodiment, brightness adjustment for tilted target display 220 may be accomplished in multiple ways. In one instance an LCD could be configured (e.g., within the projector 102) to have horizontal segments wherein brightness could be changed along slices of the image. In other instances, the segments may be vertical, circular, or a predetermined segment of the LCD or other screen. In addition, the environment sensors 146 (e.g., an external facing camera, infrared or RGB camera) could also be used to capture image data used for generating the segments and images. In other instances, a plurality of separate LCDs could be added and used. In other instances, dynamically altering a brightness per specific region could also work.

In accordance with an embodiment, at operation 313 of the method 300, the dynamic focal plane HUD module may receive additional display data for the target display 220. For example, the control device 142 may be connected (e.g., via a network) with an additional system which determines display content in whole or in part such that the dynamic focal plane HUD system 100 may act as a display device for the additional system.

In accordance with an embodiment, at operation 303 of the method, the dynamic focal plane HUD module may analyze environmental data from the environmental sensors 146 to determine one or more of hazards, paths and warnings, and then generate visible notifications thereof to be included in the target display 220. For example, the dynamic focal plane HUD system 100 may present the operator 210 with a target display 220 that includes hazards (e.g., obstacles such as potholes and other equipment) in an overlay fashion so that the operator 210 can avoid the obstacles as best as possible. The dynamic focal plane HUD system may also dynamically update the target display 220 to recommend that a driver operator stop a mobile industrial machine for determined amount of time (e.g. 20 seconds) in a particular position to allow an oncoming truck to pass (e.g., through a single-lane area or an area where a hazard or pothole has blocked a part of a roadway). In this way, the dynamic focal plane HUD system 100 may increase an efficiency of industrial equipment use, and reduce downtime caused by hazards such as potholes (e.g., which may be large and physically damaging to industrial equipment). In accordance with an embodiment, a plurality of mobile industrial machines (e.g., trucks or other vehicles), wherein each mobile industrial machine includes a dynamic focal plane HUD system 100 may be on a set of paths with junction points (e.g., within a construction site). The environmental sensors 146 (and dynamic focal plane HUD system 100) on each mobile industrial machine may determine a real-time position of the plurality of mobile industrial machines (e.g., all vehicles on a construction site), and determine paths, vehicle speeds, stops, for display on the target display 220 in order to minimize stoppages at junction points. For example, the dynamic focal plane HUD system 100 may determine and display paths in order to keep an optimum number of the plurality of mobile industrial machines at a constant speed, as much as possible. The dynamic focal plane HUD system 100 may provide operators with situational awareness in order to let another vehicle pass, or speed up, or change paths in order to optimize an overall task (e.g., movement of waste, movement of mined material, and movement of mobile industrial machines throughout an environment such as a mine). In accordance with an embodiment, the dynamic focal plane HUD system 100 can also notify an operator to alter speed/path based on regulations (e.g. dust generation, noise).

In accordance with an embodiment, the target display 220 generated by a dynamic focal plane HUD system 100 may also notify an operator to adjust speed, path, etc. to respond to hazards that develop in real-time. In accordance with an embodiment, and as part of operation 303, the determining of the one or more of hazards, paths and warnings may rely in part on an external system such as fleet management level software. The system 100 may display notifications in the target display 220 to alter speed and path based on received fleet positions/speeds (e.g., slow down/speed up at junctions). Additionally, the system 100 may also notify the operator 210 to alter speed and path based on detected path disruptions and equipment damaging hazards (e.g. potholes, water hazards, snow, dust/poor visibility, rock, traction limits, wildlife). In accordance with an embodiment, the dynamic focal plane HUD system 100 may be in communication with a database or additional system over a network, wherein the database or additional system includes data related to the environment (e.g., including hazards). In accordance with an embodiment, Machine learning (ML) or other algorithms may be used by the dynamic focal plane HUD system 100 to help sensors identify environmental hazards a work site. For example, a database of images of snow, ice, or sleet may be used to help the dynamic focal plane HUD system 100 determine that objects at a work site are indeed snow, ice and sleet, which may be incorporated into the target display 220 to alert an operator that an industrial machine they operate is near snow, ice or sleet. In other instances, the database may include images of ore or materials that an operator is tasked with gathering, whereby the dynamic focal plane HUD system 100 using the method 300 can be used to identify and locate the materials within the environment 200.

In accordance with an embodiment, potential hazards in an environment may be preprogrammed or learned. For example, a camera on the outside of a vehicle may detect rocks sliding down a slope or when a second vehicle is too close to the operator. The dynamic focal plane HUD system 100 may display a warning icon as well as video footage (e.g., from the camera) of the danger. In other instances, the dynamic focal plane HUD system 100 may display options an operator may follow to get out of the danger.

In accordance with an embodiment, potential hazards may be shared among a group of operating equipment (e.g., each with a dynamic focal plane HUD system 100) using a network. For example, a use of many environmental sensors 146 and operator sensors 144 by equipment with the group traversing a route over time could develop a detailed three-dimensional map of the route. The developed map may be shared by all equipment traversing the route to increase an accuracy of the map and to rapidly update for any new hazards discovered by any single piece of equipment.

In accordance with an embodiment, at operation 314 of the method 300, the dynamic focal plane HUD module generates a final image to display on the target display 220. The generation may include a merging of additional display data (e.g., received in operation 313), paths, hazards, warnings (e.g., from operation 303), and application of determined brightness and contrast (e.g., from operation 312) to the final image.

In accordance with an embodiment, at operation 316 of the method 300, the dynamic focal plane HUD module instructs the projector 102 to project the determined final image (e.g., towards the diffuse surface 104).

In accordance with an embodiment, the dynamic focal plane HUD system 100 may also include a plurality of focal planes (e.g., using a plurality of projectors 102 or a plurality of diffuse surfaces 104). For a dynamic focal plane HUD system 100 with a plurality of focal planes, a plurality of real images (e.g., from the plurality of projectors) may be placed at different distances to the optical mirror 106, which generates an associated plurality of virtual images at different focal planes (e.g., as seen by an operator 210 via the combiner 140). For example, a first target display 220 could be at a window of the cabin 204, a second target display 220 could be at a bucket 206, and a third target display 220 could be at a dig face 226.

In accordance with an embodiment, and shown in FIG. 4, is an example dynamic focal plane HUD system 100 implemented within a dump truck 400. In the example embodiment, the truck moves along a path (e.g., from a mining site to a processing site), carrying a load of material to be processed. As an operator within a cabin 402 moves the truck 400, many other trucks may be moving along the same path, with some in the same direction as the truck 400, and some in an opposite direction. The road may be entirely, or partially one-way, and it may be poorly-maintained, there may be obstacles, rock slides, potholes, other trucks to be avoided. As shown in FIG. 4, a target display 420 may be generated by the dynamic focal plane HUD system 100 tilted to align with a slope of a surface 410 (e.g., as described with respect to operation 306 and 310 of the method 300). As shown in FIG. 4, a light source 430 (e.g., the sun, a powerful work light) may generate light which is directly reflected 430B into a line of site of the operator and within a view 440 of the target display 420. Accordingly, at operation 312, a display brightness and contrast may be determined to counteract the affect of the light source 430.

In accordance with an embodiment, and shown in FIG. 5, is an example dynamic focal plane HUD system 100 implemented within a digger 500 (e.g., a piece of digging equipment) digging into a hillside slope 510. A cabin 502, including an operator, may be seen at the top left of the digger 500. In accordance with the example in FIG. 5, an angle of the hillside slope 510 may be significant, and a bucket 504 on the digger 500 may be blocking a large portion of the hillside slope 510 from a view of the operator (e.g., as the bucket 504 is moved). In accordance with an embodiment, a target display 520 of the example dynamic focal plane HUD system 100 may be presented on a windscreen of the cabin 502 (e.g., wherein the windscreen acts as the combiner 140 for the example dynamic focal plane HUD system 100). The target display 520 may include an image of the hillside slope 510, and may be based upon data from cameras (e.g., environment sensors 146) mounted at one or more different perspectives, potentially even mounted on the bucket 504. As the operator digs, the hillside slope 510 may change, and the target display 520 may dynamically update with the changing contours of the hillside slope 510 such that the hillside slope 510 may remain visible to the operator (e.g., via the target display 520 from the example dynamic focal plane HUD system 100), no matter a location of the bucket 504 relative to the hillside slope 510 and the operator.

In accordance with an embodiment, the systems and methods described in the present disclosure may be used with any piece of machinery requiring an operator to use vision and operate a mechanical component of a machine. Specifically, the disclosure already has application with industrial shovels, dig trucks, buckets, cranes, tractors, pallet drivers, pipeline transport vehicles, mining equipment, farming equipment, and ocean equipment.

In accordance with an embodiment, the dynamic focal plane HUD system 100 can provide instructions to an operator, wherein the instructions describe how to perform a task. For example, the dynamic focal plane HUD system 100 may first instruct (e.g., via a target display) an operator to direct machinery to particular ore for pick up. The dynamic focal plane HUD system 100 may then display arrows or highlight one or more controls that must be pressed in order for the machinery to pick up or interact with the ore. The dynamic focal plane HUD system 100 may then finally display instructions which explain to the operator how to place the ore in a particular spot.

In accordance with an embodiment, for a shovel or digging centered vehicle, a target display may show a combination of geospatial and non-geo-spatial data. Non-geo spatial oriented data may include a payload user interface UI, a truck timer, and a deviation from an optical dig path. Geo-spatial data may include, Ore body boundaries, bucket position, and position of nearby vehicles (e.g., situational awareness).

In accordance with another embodiment, additional sensors may be implemented for the dynamic focal plane HUD system 100 to display geospatial and non-geospatial data. For example, weight sensors may be fixed to a cargo portion of a truck. As material is moved out of the cargo portion of the truck, the weight sensor may detect a reduction of cargo. An animation or icon may be displayed on the dynamic focal plane HUD system 100 that corresponds to the reduction of cargo.

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

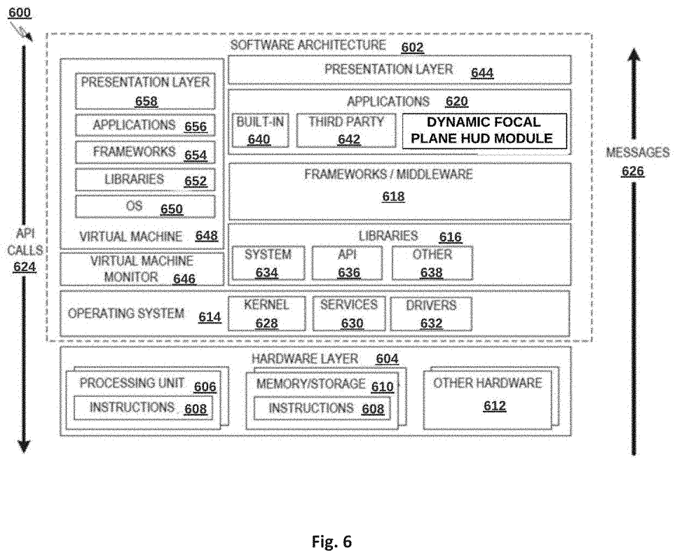

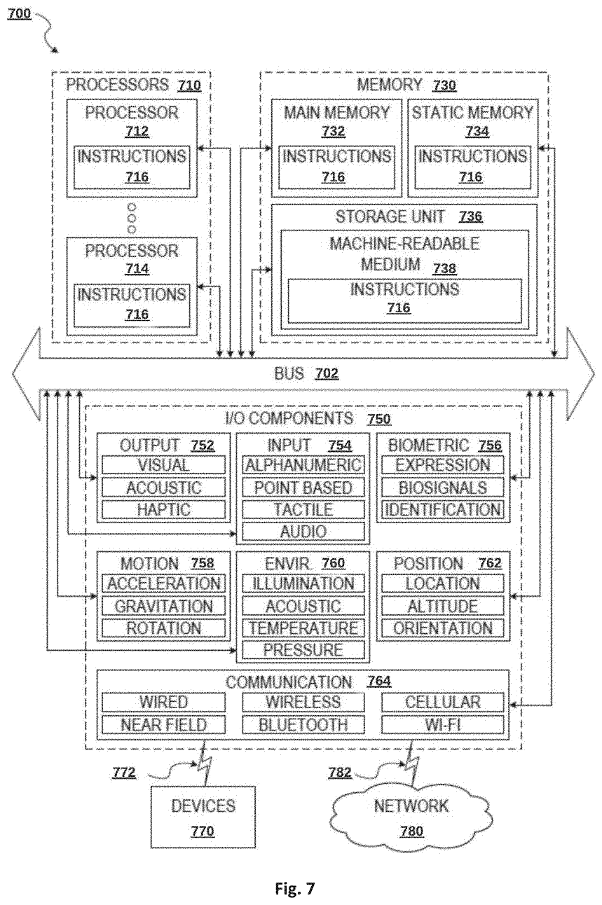

FIG. 6 is a block diagram 600 illustrating an example software architecture 602, which may be used in conjunction with various hardware architectures herein described to provide components of the dynamic focal plane HUD system 100. FIG. 6 is a non-limiting example of a software architecture and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 having associated executable instructions 608. The executable instructions 608 represent the executable instructions of the software architecture 602, including implementation of the methods, modules and so forth described herein. The hardware layer 604 also includes memory/storage 610, which also includes the executable instructions 608. The hardware layer 604 may also comprise other hardware 612.

In the example architecture of FIG. 6, the software architecture 602 may be conceptualized as a stack of layers where each layer provides particular functionality. For example, the software architecture 602 may include layers such as an operating system 614, libraries 616, frameworks or middleware 618, applications 620 and a presentation layer 644. Operationally, the applications 620 and/or other components within the layers may invoke application programming interface (API) calls 624 through the software stack and receive a response as messages 626. The layers illustrated are representative in nature and not all software architectures have all layers. For example, some mobile or special purpose operating systems may not provide the frameworks/middleware 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide common infrastructure that may be used by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 716 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL, framework that may be used to render 2D and 3D graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) provide a higher-level common infrastructure that may be used by the applications 620 and/or other software components/modules. For example, the frameworks/middleware 618 may provide various graphic user interface (GUI) functions, high-level resource management, high-level location services, and so forth. The frameworks/middleware 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a contacts application, a browser application, a book reader application, a location application, a media application, a messaging application, and/or a game application. Third-party applications 642 may include any an application developed using the Android™ or iOS™ software development kit (SDK) by an entity other than the vendor of the particular platform, and may be mobile software running on a mobile operating system such as iOS™, Android™, Windows™ Phone, or other mobile operating systems. The third-party applications 642 may invoke the API calls 624 provided by the mobile operating system such as operating system 614 to facilitate functionality described herein.

The applications 620 may use built-in operating system functions (e.g., kernel 628, services 630 and/ drivers 632), libraries 616, or frameworks/middleware 618 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with a user.

Some software architectures use virtual machines. In the example of FIG. 6, this is illustrated by a virtual machine 648. The virtual machine 648 creates a software environment where applications/modules can execute as if they were executing on a hardware machine (such as the machine 700 of FIG. 7, for example). The virtual machine 648 is hosted by a host operating system (e.g., operating system 614) and typically, although not always, has a virtual machine monitor 646, which manages the operation of the virtual machine 648 as well as the interface with the host operating system (i.e., operating system 614). A software architecture executes within the virtual machine 648 such as an operating system (OS) 650, libraries 652, frameworks 654, applications 656, and/or a presentation layer 658. These layers of software architecture executing within the virtual machine 648 can be the same as corresponding layers previously described or may be different.

FIG. 7 is a block diagram illustrating components of a machine 700, according to some example embodiments, configured to read instructions from a machine-readable medium (e.g., a machine-readable storage medium) and perform any one or more of the methodologies discussed herein. In some embodiments, the machine 700 is similar to the dynamic focal plane HUD system 100. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. As such, the instructions 716 may be used to implement modules or components described herein. The instructions transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines that individually or jointly execute the instructions 716 to perform any one or more of the methodologies discussed herein.

The machine 700 may include processors 710, memory 730, and input/output (I/O) components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 712 and a processor 714 that may execute the instructions 716. The term “processor” is intended to include multi-core processor that may comprise two or more independent processors (sometimes referred to as “cores”) that may execute instructions contemporaneously. Although FIG. 7 shows multiple processors, the machine 700 may include a single processor with a single core, a single processor with multiple cores (e.g., a multi-core processor), multiple processors with a single core, multiple processors with multiples cores, or any combination thereof.

The memory/storage 730 may include a memory, such as a main memory 732, a static memory 734, or other memory, and a storage unit 736, both accessible to the processors 710 such as via the bus 702. The storage unit 736 and memory 732, 734 store the instructions 716 embodying any one or more of the methodologies or functions described herein. The instructions 716 may also reside, completely or partially, within the memory 732, 734, within the storage unit 736, within at least one of the processors 710 (e.g., within the processor's cache memory), or any suitable combination thereof, during execution thereof by the machine 700. Accordingly, the memory 732, 734, the storage unit 736, and the memory of processors 710 are examples of machine-readable media 738.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 750 may include a wide variety of components to receive input, provide output, produce output, transmit information, exchange information, capture measurements, and so on. The specific input/output (I/O) components 750 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 750 may include many other components that are not shown in FIG. 7. The input/output (I/O) components 750 are grouped according to functionality merely for simplifying the following discussion and the grouping is in no way limiting. In various example embodiments, the input/output (I/O) components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 750 may include communication components 764 operable to couple the machine 700 to a network 780 or devices 770 via a coupling 782 and a coupling 772 respectively. For example, the communication components 764 may include a network interface component or other suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 762, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fail within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

I/we claim:

1. A system comprising:
a projector;
a concave mirror;
one or more environmental sensors;
one or more computer processors;
one or more computer memories;
a set of instructions incorporated into the one ore more computer memories, the set of instructions configuring the one or more computer processors to perform operations to generate a target display within an environment, the operations including:
gathering and analyzing data from the one or more environmental sensors to determine a target distance from a point within the system to a target display area within the environment; and
modifying a distance between the projector and the concave mirror to adjust a distance of a focal plane from the point within the system in order to match the determined target distance, wherein the focal plane is associated with the target display.

2. The system of claim 1, the system further comprising a diffuse surface and the operations further including:
analyzing data from the one or more environmental sensors to determine an orientation of the target display area; and
rotating the diffuse surface to orient the focal plane associated with the target display within the environment so that the orientation of the target display matches the determined orientation of the target display area.

3. The system of claim 1, further comprising an optical combiner and wherein the system is implemented within a machine such that an operator of the machine can see a reflection of the light from the projector off the optical combiner.

4. The system of claim 3, further comprising one or more operator sensors configured to detect a state of an operator of the machine, and wherein the operations further include:
analyzing data from the one or more operator sensors to determine a position, orientation, and gaze of the operator;
modifying the distance between the projector and the concave mirror to adjust a distance of a focal plane from the point within the optical system based on the determined position, orientation and gaze; and
modifying the orientation of the diffuse surface to adjust the orientation of the focal plane of the target display based on the determined position, orientation and gaze.

5. The system of claim 1, wherein the operations further include:
analyzing the environmental data to determine lighting conditions within the environment associated with the target display area; and
adjusting one or more of a brightness profile and a contrast profile of the target display to optimize a visibility of the target display in the target display area.

6. The system of claim 1, wherein the analyzing of data from the one or more environmental sensors includes dynamically determining the target display area within the environment.

7. The system of claim 1, wherein the optical combiner comprises a see-through material with one of the following shapes: a flat window like shape, or a window like shape with optical power.

8. A method comprising:
performing operations to generate a target display within an environment, the operations including:
gathering and analyzing data from one or more environmental sensors to determine a target distance from a point within the system to a target display area within the environment; and
modifying a distance between a projector and a concave mirror to adjust a distance of a local plane from the point within the system in order to match the determined target distance, wherein the focal plane is associated with the target display.

9. The method of claim 8, the operations further including:
analyzing data from one or more environmental sensors to determine an orientation of the target display area; and
rotating a diffuse surface to orient the focal plane associated with the target display within the environment so that the orientation of the target display matches the determined orientation of the target display area.

10. The method of claim 8, wherein the operations are performed within a machine such that an operator of the machine can see a reflection of the light from the projector off an optical combiner.

11. The method of claim 10, the operations further including:
analyzing data from one or more operator sensors to determine a position, orientation, and gaze of an operator;
modifying the distance between the projector and the concave mirror to adjust a distance of a focal plane from the point within the optical system based on the determined position, orientation and gaze; and
modifying the orientation of the diffuse surface to adjust the orientation of the focal plane of the target display based on the determined position, orientation and gaze.

12. The method of claim 8, wherein the operations further include:
analyzing the environmental data to determine lighting conditions within the environment associated with the target display area; and
adjusting one or more of a brightness profile and a contrast profile of the target display to optimize a visibility of the target display in the target display area.

13. The method of claim 8, wherein the analyzing of data from the one or more environmental sensors includes dynamically determining the target display area within the environment.

14. A tangible computer-readable storage medium storing a set of instructions that, when executed by one or more computer processors, causes the one or more computer processors to perform operations to generate a target display within an environment, the operations comprising:
gathering and analyzing data from one or more environmental sensors to determine a target distance from a point within the system to a target display area within the environment; and
modifying a distance between a projector and a concave mirror to adjust a distance of a focal plane from the point within the system in order to match the determined target distance, wherein the focal plane is associated with the target display.

15. The tangible computer-readable storage medium of claim 14, the operations further including:
analyzing data from one or more environmental sensors to determine an orientation of the target display area; and
rotating a diffuse surface to orient the focal plane associated with the target display within the environment so that the orientation of the target display matches the determined orientation of the target display area.

16. The tangible computer-readable storage medium of claim 14, wherein the operations are performed within a machine such that an operator of the machine can see a reflection of the light from the projector off an optical combiner.

17. The tangible computer-readable storage medium of claim 16, the operations further including:
analyzing data from one or more operator sensors to determine a position, orientation, and gaze of an operator;
modifying the distance between the projector and the concave mirror to adjust a distance of a focal plane from the point within the optical system based on the determined position, orientation and gaze; and
modifying the orientation of the diffuse surface to adjust the orientation of the focal plane of the target display based on the determined position, orientation and gaze.

18. The tangible computer-readable storage medium of claim 14, wherein the operations further include:
analyzing the environmental data to determine lighting conditions within the environment associated with the target display area; and
adjusting one or more of a brightness profile and a contrast profile of the target display to optimize a visibility of the target display in the target display area.

19. The tangible computer-readable storage medium of claim 14, wherein the analyzing of data from the one or more environmental sensors includes dynamically determining the target display area within the environment.

20. The tangible computer-readable storage medium of claim 14, wherein the optical combiner comprises a see-through material with one of the following shapes: a flat window like shape, or a window like shape with optical power.
